(19) United States
(12) Patent Application Publication
(10) Pub. No.: US 2020/0262381 A1
(43) Pub. Date: Aug. 20, 2020

(54) SYSTEMS AND METHODS FOR CONTROLLING AIRBAGS

(71) Applicant: SIKORSKY AIRCRAFT CORPORATION, Stratford, CT (US)

(72) Inventors: Charles W. Clarke, Sag Harbor, NY (US); Marcus D. Cappelli, Shelton, CT (US); Walter T. Mayo, IV, (US)

(21) Appl. No.: 15/774,525

(22) PCT Filed: Oct. 28, 2016
(86) PCT No.: PCT/US16/59311

§ 371 Date: May 8, 2018

Related U.S. Application Data
(60) Provisional application No. 62/252,788, filed on Nov. 9, 2015.

(51) Int. Cl. B60R 21/015; B60R 21/013; B60R 21/26

(52) U.S. Cl. CPC B60R 21/01512; B60R 2021/0093; B60R 21/26; B60R 21/013

(57) ABSTRACT

A method for controlling deployment of an airbag relative to ground contact includes retrieving a predicted ground contact time for an aircraft from a crash prediction module, retrieving seat position measurements and occupant data for a seat in the aircraft, and comparing the predicted ground contact time, the seat position measurements and the occupant data to pre-established data to determine a custom airbag deployment time with respect to the predicted ground contact time, for at least one airbag on the aircraft. The method includes sending a signal to deploy the at least one airbag based on the custom airbag deployment time.

### CROSS REFERENCE TO RELATED APPLICATIONS

This application claims the benefit of and priority to U.S. Provisional Application Ser. No. 62/252,788 filed Nov. 9, 2015, the disclosure of which is herein incorporated by reference in its entirety.

### STATEMENT REGARDING FEDERALLY SPONSORED RESEARCH OR DEVELOPMENT

This invention was made with government support under Contract No. W911 W6-12-2-0005 with the United States Army. The government has certain rights in the invention.

### BACKGROUND OF THE INVENTION

### 1. Field of the Invention

The present disclosure relates to airbag systems, and more particularly airbag systems on aircraft, for example, rotorcraft.

### 2. Description of Related Art

Many aircraft, for example, rotorcraft, include airbag systems, such as cockpit airbag systems. Typically, airbag systems are designed to generally protect as many occupants as possible across a broad range of heights and weights. Cockpit airbag systems, for example, are even more complex due to the wide variety of crash scenarios and additional factors to consider.

Such conventional methods and systems have generally been considered satisfactory for their intended purpose. However, there is still a need in the art for improved methods and systems for controlling the deployment of airbags. The present disclosure provides a solution for this need.

### SUMMARY OF THE INVENTION

A method for controlling deployment of an airbag relative to ground contact includes retrieving a predicted ground contact time for an aircraft from a crash prediction module, retrieving seat position measurements and occupant data for a seat in the aircraft, and comparing the predicted ground contact time, the seat position measurements and the occupant data to pre-established data to determine a custom airbag deployment time with respect to the predicted ground contact time, for at least one airbag on the aircraft. The method includes sending a signal to deploy the at least one airbag based on the custom airbag deployment time.

In accordance with some embodiments, seat position measurements include a seat height measurement with respect to an aircraft floor, a forward-aft seat position measurement with respect to a neutral seat position, and/or a forward-aft seat position measurement with respect to a foot pedal. The occupant data can include at least one of occupant weight or height. Retrieving the seat position measurements and the occupant data for the seat can include retrieving the seat position measurements and the occupant data for the seat in a continuous loop in order to account for any changes. Retrieving the seat position measurements and the occupant data for the seat can include receiving signals from at least one sensor operatively connected to the seat.

It is contemplated that the pre-established data can include a range of pre-established custom airbag deployment times correlated to the predicted ground contact time, the seat position measurements and/or the occupant data. Sending the signal to deploy the at least one airbag based on the custom airbag deployment time can include sending the signal to a gas generator operatively connected to the airbag to fill the at least one airbag. The custom airbag deployment time can be calibrated for a gas generation time and a filling time for the gas generator to generate gas and fill the at least one airbag with the gas.

An airbag deployment system includes an airbag deployment module having a processor operatively connected to at least one airbag. The processor is configured to perform the method as described above.

It is contemplated that the system can include an energy attenuating seat and at least one sensor operatively connected to the energy attenuating seat to obtain the seat position measurements and the occupant data. The system can include a foot pedal and at least one sensor operatively connected to the foot pedal to obtain a foot pedal position in order to determine a forward-aft seat position measurement with respect to the foot pedal. The system can include a gas generator operatively connected between the airbag deployment module and the at least one airbag.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic view of an exemplary embodiment of a vertical take-off and landing (VTOL) aircraft, showing an airbag deployment system constructed in accordance with the present disclosure;

FIG. 2 is a schematic side view of the airbag deployment system of FIG. 1, showing a front airbag being deployed;

FIG. 3 is a schematic aft-facing view of e airbag deployment system of FIG. 1, showing a side airbag being deployed; and

FIG. 4 is a flowchart of an exemplary method for controlling the deployment of an airbag in accordance with the present disclosure, showing operations to determine a custom airbag deployment time with respect to the predicted ground contact time and to send a signal to deploy at least one of the airbags based on the custom airbag deployment time.

### DETAILED DESCRIPTION OF THE PREFERRED EMBODIMENTS

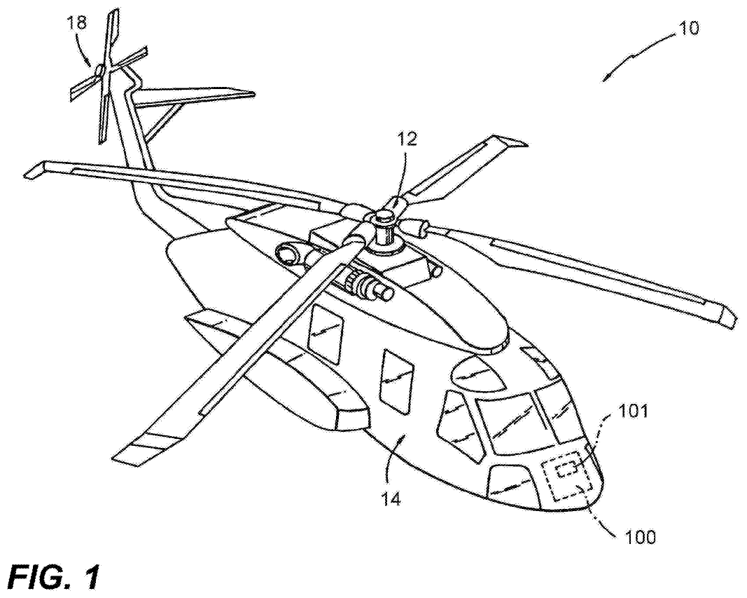

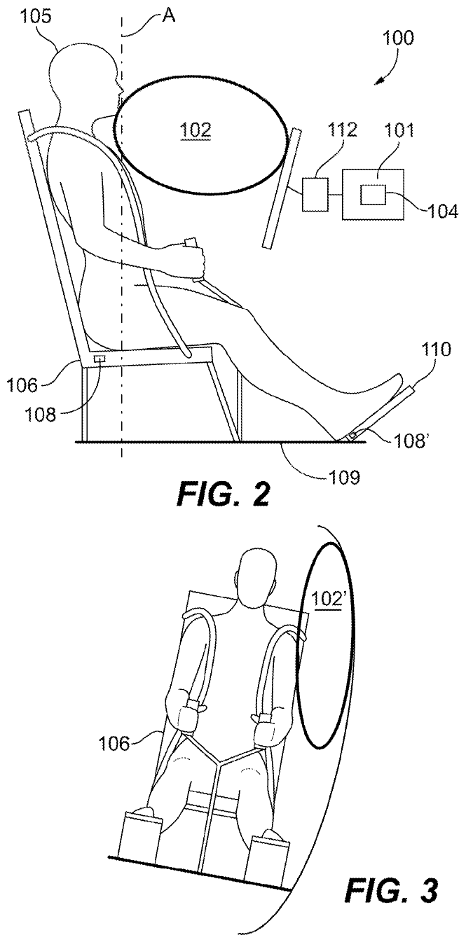

Reference will now be made to the drawings wherein like reference numerals identify similar structural features or aspects of the subject disclosure. For purposes of explanation and illustration, and not limitation, a partial view of an exemplary embodiment of a vertical takeoff and landing (VTOL) aircraft in accordance with the disclosure is shown in FIG. 1 and is designated generally by reference character 10. Other embodiments of VIOL aircraft in accordance with the disclosure, or aspects thereof, are provided in FIGS. 2-4, as will be described. The systems and methods described herein provide custom airbag deployment timing, which tends to reduce the chances of airbag deployment induced injury during a crash or other impact scenario.

As shown in FIG. 1, VIOL aircraft 10 includes a main rotor system 12 and tail rotor system 18 supported by an airframe 14, VTOL aircraft 10 also includes an airbag deployment system 100 having an airbag deployment module 101. Those skilled in the art will readily appreciate that while airbag deployment system 100 is described in the context of a VTOL aircraft, system 100 can be used in a variety of aerospace and industrial applications. Moreover, while shown on VTOL aircraft 10, portions of system 100 can also be outside of aircraft 10 but operatively connected thereto, for example, through wireless communication.

With reference now to FIG. 2, airbag deployment system 100 includes an airbag 102 operatively connected to airbag deployment module 101. VTOL aircraft 10 includes a gas generator 112 as part of system 100. Gas generator 112 is operatively connected to airbag deployment module 101 and airbag 102. When triggered, gas generator 112 generates the fill gas and force to deploy airbag 102. VTOL aircraft 10 includes an energy attenuating seat 106 as part of system 100 and a sensor 108 operatively connected to energy attenuating seat 106 to obtain the seat position measurements and the occupant data. Energy attenuating seat 106 is configured to stroke downward and/or upward along chair axis A during a crash scenario in order to alleviate the G-forces acting on an occupant 105. Sensor 108 can be a weight sensor, seat height sensor, potentiometer, current dial, or the like. It is also contemplated that seat 106 can include more than one sensor 108 to account for both seat height and weight, and/or any other desired characteristic. Those skilled in the art will also appreciate that manual inputs for seat height position, forward-aft seat position and/or occupant height and weight, can also be used. Energy attenuating seat 106 can include adjustments for the occupant's weight and height. It is contemplated that in some embodiments, the seat adjustments from energy attenuating seat 106 can be used to determine the height and weight of the occupant for use the method described below.

With continued reference to FIG. 2, VTOL aircraft 10 includes a foot pedal 110 as part of system 100 and a sensor 108′ operatively connected to foot pedal 110 to obtain a foot pedal position in order to determine a forward-aft seat position measurement with respect to foot pedal 110. Those skilled in the art will readily appreciate that forward-aft seat position refers to the position of seat 106 in either the forward or aft direction with respect to aircraft 10, e.g. a direction substantially perpendicular to axis A as depicted in FIG. 2 (forward direction to the right and aft direction to the left). Airbag deployment module 101 includes a processor 104 operatively connected to airbag 102. Processor 104 is configured to perform the method described below.

As shown in FIG. 3, airbag deployment system 100 includes a side airbag 102′. It is contemplated that side airbag 102′ can also be operatively connected to airbag deployment module 101 through its own gas generator or gas generator 112. Those skilled in the art will readily appreciate that while two airbags 102 and 102′ are shown, any suitable number of air bags may be controlled with a single airbag deployment module 101, Additionally, it is contemplated that each airbag 102, and 102′ can each have its own respective airbag deployment module. Airbag 102′ can be timed for deployment in conjunction with airbag 102, or, its own custom airbag deployment time can be determined using the method described below.

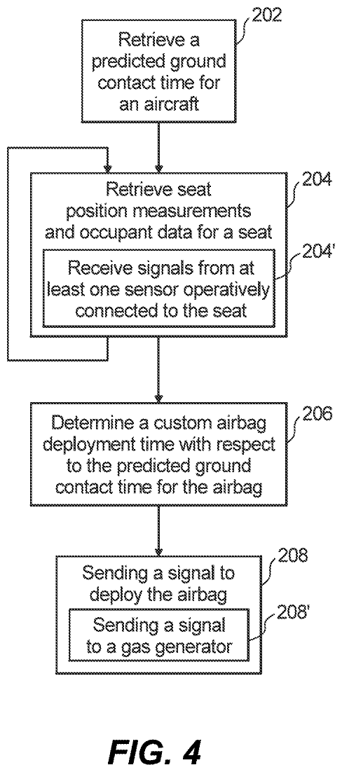

With reference now to FIG. 4, processor 104 is configured to perform a method 200 for controlling deployment of an airbag, e.g. airbag 102 and/or 102′, relative to ground contact. Method 200 includes retrieving a predicted ground contact time for an aircraft, e.g. aircraft 10, from a crash prediction module, as shown by box 202. Those skilled in the art will readily appreciate that the term ground contact is not limited to contact with ground, but can include a variety of contact or impact scenarios, such as, contact with a flight deck, water, dry ground, etc.

With continued reference to FIG. 4, method 200 includes retrieving seat position measurements and occupant data for a seat, e.g. seat 106, in the aircraft, as shown by box 204. Seat position measurements include a seat height measurement with respect to an aircraft floor, e.g. floor 109, a forward-aft seat position measurement with respect to a neutral seat position, and/or a forward-aft seat position measurement with respect to a foot pedal, e.g. foot pedal 110. The occupant data includes occupant weight and/or height. It is contemplated that retrieving the seat position measurements and the occupant data for the seat includes retrieving the seat position measurements and the occupant data for the seat in a continuous loop in order to account for any changes, for example, seat height adjustment during flight. Retrieving the seat position measurements and/or the occupant data for the seat includes receiving signals from at least one sensor operatively connected to the seat, as indicated by box 204′. It is also contemplated that retrieving the seat position measurements and/or the occupant data for the seat can include receiving manual inputs, and/or receiving adjustment data from the energy attenuating seat, as described above.

As shown in FIG. 4, method 200 includes comparing the predicted ground contact time, the seat position measurements and the occupant data to pre-established data to determine a custom airbag deployment time with respect to the predicted ground contact time for the airbag, as shown by box 206. It is contemplated that the pre-established data is a database that includes a range of pre-established custom airbag deployment times correlated to given predicted ground contact times, seat position measurements and/or occupant data. Pre-established data is generated during flight test based on deployment times relative to ground contact, e.g. impact, for a given height, weight, seat position and/or any other suitable characteristic. Deployment times for system 100 can be pre-impact, at impact or post-impact, while traditional systems typically only accommodate at-impact or post-impact deployment because they are generally triggered by the impact itself.

Method 200 includes sending a signal to deploy the airbag based on the custom airbag deployment time, as shown by box 208. Sending the signal to deploy the airbag based on the custom airbag deployment time includes sending the signal to a gas generator, e.g. gas generator 112, operatively connected to the airbag to fill the airbag, as indicated by box 208′. The custom airbag deployment time can be calibrated for a gas generation time and a filling time for the gas generator to generate gas and fill the airbag with the gas. As discussed above, method 200 can operate to send a signal to deploy more than one airbag based on one custom airbag deployment time, or can determine a custom airbag deployment time for each airbag, e.g. one for front airbag 102 and one for side airbag 102′.

The methods and systems of the present disclosure, as described above and shown in the drawings, provide for systems and methods for controlling airbag systems that provide customized deployment times depending on the occupant and seat position characteristics in order to minimize airbag deployment induced injuries. While the apparatus and methods of the subject disclosure have been shown and described with reference to preferred embodiments, those skilled in the art will readily appreciate that changes and/or modifications may be made thereto without departing from the spirit and scope of the subject disclosure.

1. A method for controlling deployment of an airbag relative to ground contact, the method comprising:
retrieving a predicted ground contact time for an aircraft from a crash prediction module;
retrieving seat position measurements and occupant data for a seat in the aircraft;
comparing the predicted ground contact time, the seat position measurements and the occupant data to pre-established data to determine a custom airbag deployment time with respect to the predicted ground contact time, for at least one airbag on the aircraft; and
sending a signal to deploy the at least one airbag based on the custom airbag deployment time.

2. The method as recited in claim 1, wherein the seat position measurements include at least one of a seat height measurement with respect to an aircraft floor, a forward-aft seat position measurement with respect to a neutral seat position, or a forward-aft seat position measurement with respect to a foot pedal.

3. The method as recited in claim 1, wherein the occupant data includes at least one of occupant weight or height.

4. The method as recited in claim 1, wherein retrieving the seat position measurements and the occupant data for the seat includes retrieving the seat position measurements and the occupant data for the seat in a continuous loop in order to account for any changes.

5. The method as recited in claim 1, wherein the pre-established data includes a range of pre-established custom airbag deployment times correlated to at least one of the predicted ground contact time, the seat position measurements or the occupant data.

6. The method as recited in claim 1, wherein retrieving the seat position measurements and the occupant data for the seat includes receiving signals from at least one sensor operatively connected to the seat.

7. The method as recited in claim 1, wherein sending the signal to deploy the at least one airbag based on the custom airbag deployment time includes sending the signal to a gas generator operatively connected to the airbag to fill the at least one airbag.

8. The method as recited in claim 7, wherein the custom airbag deployment time is calibrated for a gas generation time and a filling time for the gas generator to generate gas and fill the at least one airbag with the gas.

9. An airbag deployment system comprising:
an airbag deployment module having a processor operatively connected to at least one airbag, wherein the processor is configured to:
retrieve a predicted ground contact time for an aircraft from the crash prediction module;
retrieve seat position measurements and occupant data for a seat in the aircraft;
compare the predicted ground contact time, the seat position measurements and the occupant data to pre-established data to determine a custom airbag deployment time with respect to the predicted ground contact time, for the at least one airbag; and
send a signal to deploy the at least one airbag based on the custom airbag deployment time.

10. The system as recited in claim 9, wherein the seat position measurements include at least one of a seat height measurement with respect to an aircraft floor, a forward-aft seat position measurement with respect to a neutral seat position, or a forward-aft seat position measurement with respect to a foot pedal.

11. The system as recited in claim 9, wherein the occupant data includes at least one of occupant weight or height.

12. The system as recited in claim 9, wherein the pre-established data includes a range of pre-established custom airbag deployment times correlated to at least one of the predicted ground contact time, the seat position measurements or the occupant data.

13. The system as recited in claim 9, further comprising an energy attenuating seat, and at least one sensor operatively connected to the energy attenuating seat to obtain the seat position measurements and the occupant data.

14. The system as recited in claim 9, further comprising a foot pedal and at least one sensor operatively connected to the foot pedal to obtain a foot pedal position in order to determine a forward-aft seat position measurement with respect to the foot pedal.

15. The system as recited in claim 9, further comprising a gas generator operatively connected between the airbag deployment module and the at least one airbag, wherein the signal to deploy the at least one airbag based on the custom airbag deployment time is sent to the gas generator.

16. The system as recited in claim 15, wherein the custom airbag deployment time is calibrated for a gas generation time and a filling time for the gas generator to generate gas and fill the at least one airbag with the gas.
